(19) United States
(12) Patent Application Publication
(10) Pub. No.: US 2003/0133581 A1
(43) Pub. Date: Jul. 17, 2003

(54) User configurable multi-component speaker panel

(76) Inventor: Arnold I. Klayman, Huntington Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/338,117

(22) Filed: Jan. 7, 2003

Related U.S. Application Data
(60) Provisional application No. 60/346,954, filed on Jan. 7, 2002.

(51) Int. Cl. H04R 25/00

(52) U.S. Cl. 381/152; 381/390; 381/386

(57) ABSTRACT

A loudspeaker assembly comprises at least one mid-range speaker with a substantially planar diaphragm comprised of a lightweight material. The diaphragm can include a support shield to prolong the operating lifetime of the loudspeaker assembly. The loudspeaker assembly further comprises at least one high-range speaker. The loudspeaker assembly further comprises two posts. The at least one mid-range speaker and the at least one high-range speaker can be positioned between the two posts during assembly. The relative positions of the at least one mid-range speaker, and the at least one high-range speaker are adjustable.

### RELATED APPLICATION

This application claims priority under 35 U.S.C. §119(e) from U.S. Provisional Patent Application Serial No. 60/346,954, entitled “Multi-Component Speaker Panel with User Adaptability” and filed Jan. 7, 2002, the entire disclosure which is hereby incorporated by reference in its entirety.

### FIELD OF THE INVENTION

The present invention relates to a slim-panel, multi-component speaker device adapted for increased operating lifetime and user-configurability.

### BACKGROUND OF THE INVENTION

The greatly increased use and application of sound reproduction equipment, and the vast improvements in the fidelity of stereo and audio equipment, has resulted in a demand for loudspeakers capable of meeting critical acoustical specifications. Many conventional loudspeakers are capable of meeting these specifications, although such loudspeakers generally have increased size, weight and thickness requirements. Thus, it has been suggested that loudspeakers can be provided with stiff, lightweight diaphragms formed of cellular plastic materials, such as described in U.S. Pat. Nos. 1,824,664; 2,905,260; 3,046,362; 3,569,638; and 3,718,779; and in British Patent 510,707, all of which are hereby incorporated herein by reference in their entirety and are hereby made a part of this specification. Such loudspeakers have the advantage of being thin and lightweight while still faithfully reproducing sounds over a broad range of frequencies with a minimum of distortion.

Another important aspect of any sound reproduction equipment is user configurability. Individual listeners may wish to adjust the audio characteristics when listening to loudspeakers depending, for example, on the type of audio program being played. One way of adjusting these audio characteristics is to use an equalizer to selectively amplify certain frequencies by various amounts for playback. Audio characteristics can also be adjusted by changing the placement and orientation of the loudspeakers with respect to the placement and orientation of the listener.

### SUMMARY OF THE INVENTION

In accordance with the foregoing background information, it is desired to have a compact and lightweight loudspeaker assembly that incorporates slim-panel speaker diaphragms and other components to provide a full-range high-quality loudspeaker. It is further desired that such a loudspeaker assembly comprise speaker components adapted to have their location and orientation easily configured by the listener.

Conventional loudspeakers having slim-panel diaphragms formed of cellular plastic materials tend to have a reduced operating lifetime due to their thin and lightweight construction. Specifically, many commercially available cellular plastic materials do not have adequate structural strength to withstand the vibrations created during reproduction of many audio programs, especially at higher volumes and higher frequencies. Thus, it is further desired to have a cellular plastic loudspeaker diaphragm that has an increased operating lifetime and that is resistant to failure at high volumes and high frequencies.

According to one embodiment, a loudspeaker assembly comprises at least one mid-range speaker with a substantially planar diaphragm comprised of a lightweight material. The loudspeaker assembly further comprises at least one high-range speaker. The loudspeaker assembly further comprises two posts. The at least one mid-range speaker and the at least one high-range speaker can be positioned between the two posts during assembly. The relative positions of the at least one mid-range speaker, and the at least one high-range speaker are adjustable.

According to another embodiment, a method for configuring a loudspeaker assembly comprises providing a plurality of loudspeaker components. The method further comprises providing two posts configured to receive the plurality of loudspeaker components therebetween. The method further comprises positioning the plurality of loudspeaker components between said posts according to a user's listening preferences.

### BRIEF DESCRIPTION OF THE DRAWINGS

The preferred embodiments of the user configurable multi-component speaker panel, illustrating its features, will now be discussed in detail. These embodiments depict the novel and non-obvious user configurable multi-component speaker panel shown in the accompanying drawings, which are for illustrative purposes only. These drawings include the following figures, in which like numerals indicate like parts.

FIG. 1 is a perspective view of a typical form of sound reproducing assembly.

FIG. 2 is a front elevation of the frame of the equipment illustrated in FIG. 1 with the diaphragm removed therefrom.

FIG. 3 is a transverse sectional view through the equipment illustrated in FIG. 1 take on the line 3-3 thereof.

FIG. 4 is a rear view of the assembly illustrated in FIG. 1.

FIG. 5 is a sectional view through a portion of the frame and diaphragm taken on the line 5-5 of FIG. 4.

FIG. 6 is a rear elevation of the diaphragm embodied in the sound reproducing equipment of FIGS. 1 through 5.

FIG. 7 is an enlarged sectional view of a portion of the diaphragm illustrated in FIG. 6, taken on the line 7-7 thereof

FIG. 8 is a sectional view through the voice coil form and the diaphragm having a preferred type of high frequency propagator carried thereby.

FIG. 9 is a front view of a flat panel diaphragm having a support structure affixed thereon.

FIG. 10 is a rear view of a flat panel diaphragm having a support structure affixed thereon.

FIG. 11 is a front view of a user configurable multi-component speaker panel.

FIG. 12 is a side view of the user configurable multi-component speaker panel illustrated in FIG. 11.

FIG. 13 is a rear view of the user configurable multi-component speaker panel illustrated in FIG. 11.

FIG. 14 is an exploded perspective view of the various components comprising the user configurable multi-component speaker panel illustrated in FIG. 11.

FIG. 15 is a cross-sectional view taken along the line 15-15 of FIG. 13.

### DETAILED DESCRIPTION OF PREFERRED EMBODIMENTS

As described above, it is desired to have a compact and lightweight loudspeaker assembly that incorporates slim-panel speaker diaphragms and other components to provide a full-range high-quality loudspeaker. The slim-panel speaker diaphragms preferably are configured to have an extended operating lifetime, and to be resistant to cracking due to stresses incurred at high frequencies and volumes. It is further desired that such a loudspeaker assembly comprise speaker components adapted to have their location and orientation easily configured by the listener.

A. Description of a Novel and Non-obvious Slim-panel Speaker Diaphragm.

The slim-panel speaker diaphragm disclosed herein is thin, lightweight, and can be used in widely varying temperature and humidity conditions, and in equipment and locations presenting unusual requirements in these respects. Such a slim-panel speaker diaphragm, and its mounting as disclosed herein, also permit the faithful reproduction of sounds over a range of frequencies extending from, for example, 40 Hz to 20 kHz with a minimum of distortion.

As discussed above, the greatly increased use and application of sound reproduction equipment, and the vast improvements in the fidelity of stereo and audio equipment, has resulted in a demand for devices capable of meeting critical acoustical specifications while imposing limitations such as reduced size, weight and thickness, or unusual conditions of operation such as wide ranges in temperature and severe conditions of humidity.

While certain of these operational demands can be met by the use of special and unusual compositions or constructions, the advantages produced in any one or more of these respects are generally attained at the expense of other important characteristics. For example, it has been suggested that sound reproducing equipment may be provided with a relatively thin flat diaphragm instead of the more usual cone type of loudspeaker. See, for example, U.S. Pat. Nos. 1,498,384; 1,746,289; 1,802,826; 2,047,367; and 3,236,958, all of which are hereby incorporated herein by reference. Such diaphragms generally comprise wood or other relatively heavy materials, and while they are of particular advantage in the faithful reproduction of low-frequency sounds, or as “woofers”, their weight and inertia, and the power required to actuate the same generally precludes their use in light weight equipment, or for reproducing high-frequency sounds and notes in the upper range of musical tones. It is therefore necessary in such equipment to provide a separately mounted and energized high frequency device or “tweeter” to reproduce a relatively wide range of sound frequencies.

Alternatively, it has been suggested that loudspeakers may be provided with stiff, light weight, diaphragms formed of cellular plastics materials as exemplified by U.S. Pat. Nos. 1,824,664; 2,905,260 and 3,046,362; as well as British Patent 510,707, all of which are hereby incorporated herein by reference. However, when such stiff, light weight diaphragms are formed in a substantially flat shape, it is found that they have a marked tendency to undergo mid- and high-frequency “breakup” (that is, structural failure) due to vibration of the central and peripheral portions of the diaphragm at different frequencies or out of phase with due other, thus creating intermediate nodal points and zones within the diaphragm which result in sound distortions.

Furthermore, in practically all sound reproducing equipment heretofore produced there has been a marked disparity between the characteristics and acoustical properties of the diaphragm on the one hand, and those of the frame and elements by which the diaphragm and magnetic elements associated with the voice coil are mounted on the other. Consequently, the latter elements may set up vibrations of their own independently of the diaphragm and voice coil when the equipment is actuated. Thus, there is a tendency for interfering vibrations to be fed back to elements of the loudspeaker equipment so as to create poor frequency response, distortion, buzzing, and parasitic noises which impair the quality of the sounds produced.

The various embodiments disclosed herein address the limitations of conventional loudspeaker assemblies, and provide thin, light weight, sound reproducing equipment capable of use under widely varying and adverse conditions of operation. The quality of the tones or sounds produced by such embodiments is materially improved and rendered consistent over a range of frequencies which may extend from 40 to 20 kHz or greater.

As illustrated in FIG. 1, a preferred embodiment of a sound reproducing assembly comprises a flat marginal frame 2, which as shown, is rectangular in shape and is provided with side members 4, 6, 8 and 10. The inner edges of the side members of the frame 2 are provided with inwardly projecting diaphragm supporting ledges 12 which, as shown in FIGS. 2 and 3, lie in a common plane facing the front 14 of the frame, as seen in FIG. 1. The marginal portions 16 of a thin, flat, stiff and lightweight diaphragm 18 are supported on the ledges 12 and surrounded by shoulders 20 which are of a height approximately equaling the thickness of the diaphragm. Inclined surfaces 22 extend outwardly from the upper edges of the shoulders 20 to the front 14 of the frame so as to present an outwardly flaring horn-like surface about the edges of the diaphragm 18.

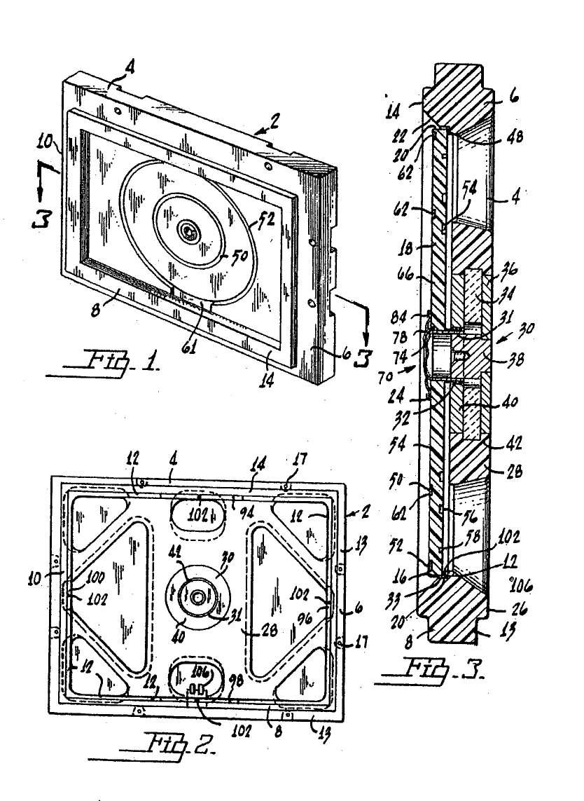

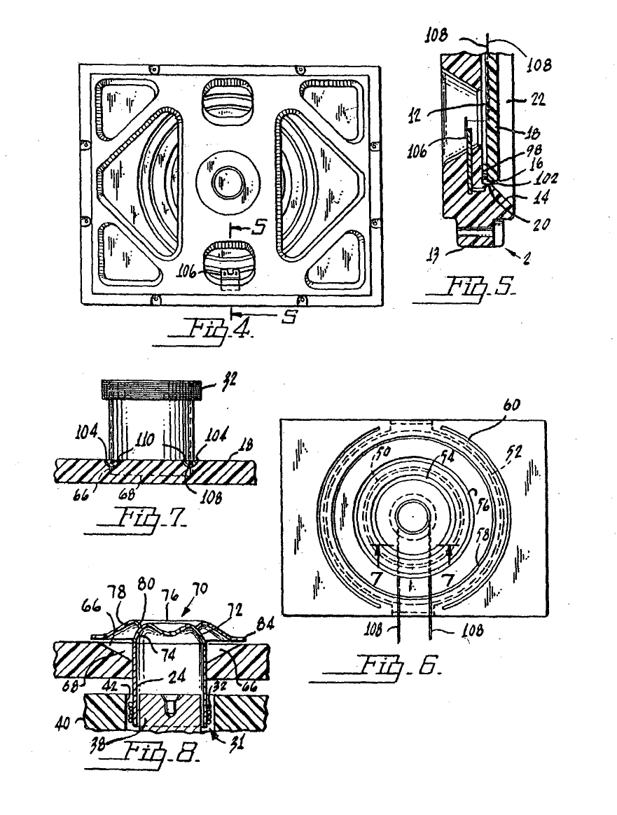

As shown in FIGS. 3 and 5, the frame 2 has an outer edge or flange 13 which can be received within a channeled or other mounting support to enable the assembly to be secured in place in a suitable mounting device (discussed in greater detail below). The assembly can then be concealed by cloth or fabric covers or by any other suitable or decorative material through which the sounds produced can penetrate without distortion. In a modified embodiment, the unit can be used as an element or panel in a ceiling, wall, furniture or elsewhere as desired.

As illustrated in FIG. 3, a tubular voice coil form 24 is secured to the flat diaphragm 18 adjacent the center thereof and projects toward the opposite or rear face 26 of the frame 2.

A magnet supporting rib 28 has the opposite ends thereof secured to opposite side members of the frame 2, such as the side members 4 and 8, and has a magnetic assembly 30 carried thereby and presenting an air gap 31 surrounding the voice coil from 24 and the voice coil 32 which is mounted on the form 24.

The magnet supporting rib 28 is preferably also formed of material which is the same or similar in its acoustical or physical properties with the frame and diaphragm 18. Thus, the frame 2, diaphragm 18 and magnet supporting rib 28 can all be formed of expanded cellular plastic material or other acoustical compatible plastic material such as a solidified foam or expanded beads of polystyrene. An alternative construction using such acoustically compatible materials embodies a frame 2 and supporting rib 28 in the form of a single, integral and unitary molded assembly, which can be produced by injection molding or otherwise and composed of unexpanded plastic material having a density ranging from about 0.8 to 10.0 pounds per cubic foot. In other embodiments, the diaphragm 18 comprises a stiff, lightweight plastic material of a similar nature but having an expanded or cellular form. A typical composition adopted for use in forming the diaphragm is expanded polystyrene, preferably having a density ranging from about 0.8 to 1.8 pounds per cubic foot.

While the density of the material used in forming the frame and magnet supporting rib can be somewhat higher than that used in forming the diaphragm, and in some instances is, as indicated above, formed of unexpanded or non-cellular material, it is preferable to use materials in forming the frame and magnet support which are sufficiently similar or compatible with the material used in forming the diaphragm so that the major elements of the entire assembly will have matching acoustical and physical characteristics, thus presenting a reduced tendency to cause independent and/or interfering vibrations or to undergo substantially different changes when subjected to widely differing conditions of temperature, humidity and the like.

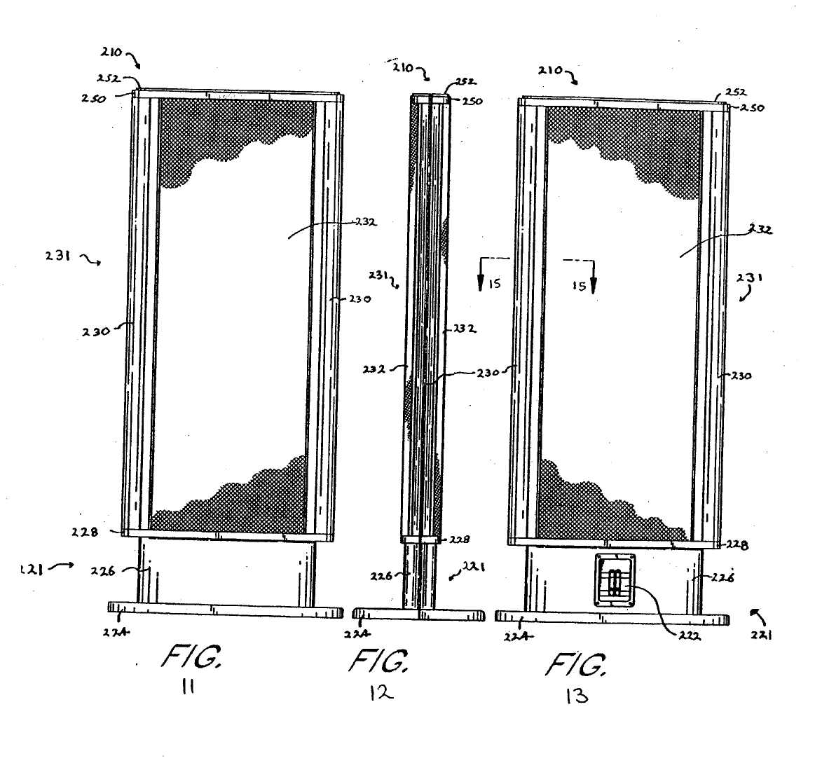

The magnet supporting rib 28 is secured to the frame 2 adjacent the rear face 26 of the frame 2 and is spaced from and extends parallel to the diaphragm 18 as shown in FIG. 3. The magnetic assembly 30 is fixedly secured to the magnet supporting rib 28 and is held in fixed position thereby. Further, as shown in FIG. 3, the magnetic assembly 30 is preferably molded in place within the supporting rib 28 in position to surround the voice coil 32 carried by the voice coil form 24 on diaphragm 18. The assembly 30 includes a permanent magnet 34 which can be formed of a magnetic alloy such as “Alnico” or a ceramic material such as “Indox” or the like. The magnet 34 is provided with a rear plate 36 and a central pole piece 38 both of which are preferably formed of ferromagnetic material. A front plate or pole piece 40 is also preferably formed of ferromagnetic material and contacts the permanent magnet 34. A central opening 42 in the pole piece 40 surrounds the voice coil 32 on the voice coil form 24. The sides of the central opening 42 in pole piece 40 are spaced from the central pole piece 38 so as to provide the air gap 31 of limited cross section in which the voice coil 32 of the diaphragm is located, as indicated in FIG. 8.

In a preferred embodiment, the exposed faces of the rear and front plates 36 and 40 are substantially flush with the front and rear surfaces of the magnet supporting rib 28 whereas the permanent magnet 34 is larger in diameter than said plates so as to project outward beyond the same as shown at central opening 42 to become securely imbedded in the molded cellular plastic material. In this way the magnetic assembly 30 is not only fixedly secured in place with respect to the magnet supporting rib 28 but is also fixedly secured in place with respect to the axis of the voice coil 32. Moreover, even though the various embodiments disclosed herein may be subjected to widely varying conditions of temperature and humidity, the components will be retained in the same accurately disposed relation with respect to each other by reason of the similarity or identity of the materials employed in forming the frame 2, the magnet supporting rib 28 and the diaphragm 18.

As described above, the diaphragm 18 preferably comprises stiff, lightweight, expanded polystyrene, or other cellular plastic material, and in most instances has a thickness of about one-sixteenth to one-half inch depending upon the size and type of the sound reproducing equipment with which the diaphragm 18 is to be used. In addition, to permit the equipment to produce a wide range of sounds, varying in frequency from, for example, 40 Hz to 20 kHz, it is desirable to construct and mount the diaphragm in a way that reduces or eliminates the tendency to produce undesired “break-up” or nodal lines, zones or points within the diaphragm during vibration thereof.

Accordingly, the diaphragm 18 is preferably provided with compliance rings, lines, or corrugations which are located between the centrally located voice coil form 24 and the periphery or marginal edges 16 of the diaphragm. Furthermore, it is also desirable to secure the marginal edges 16 of the diaphragm to the supporting ledges 12 of the frame 2 in a manner to enable the entire diaphragm to serve as a sound generating piston capable of reproducing tones or vibrations in the lowest audible or subaudible range.

As illustrated in the drawings, these advantages are attained by providing sufficient clearance 33 between the outer edges of the marginal portions 16 of the diaphragm and the surrounding shoulder 20 of the frame to allow the diaphragm to flex without restraint being imposed on the edges of the diaphragm by the shoulders. Moreover, the marginal portions 16 of the diaphragm are secured to the ledges 12 of the frame in a yieldable or flexible way. For example, an adhesive such as a silicone rubber or other strong but yieldable cement 48 has been found to be particularly suitable.

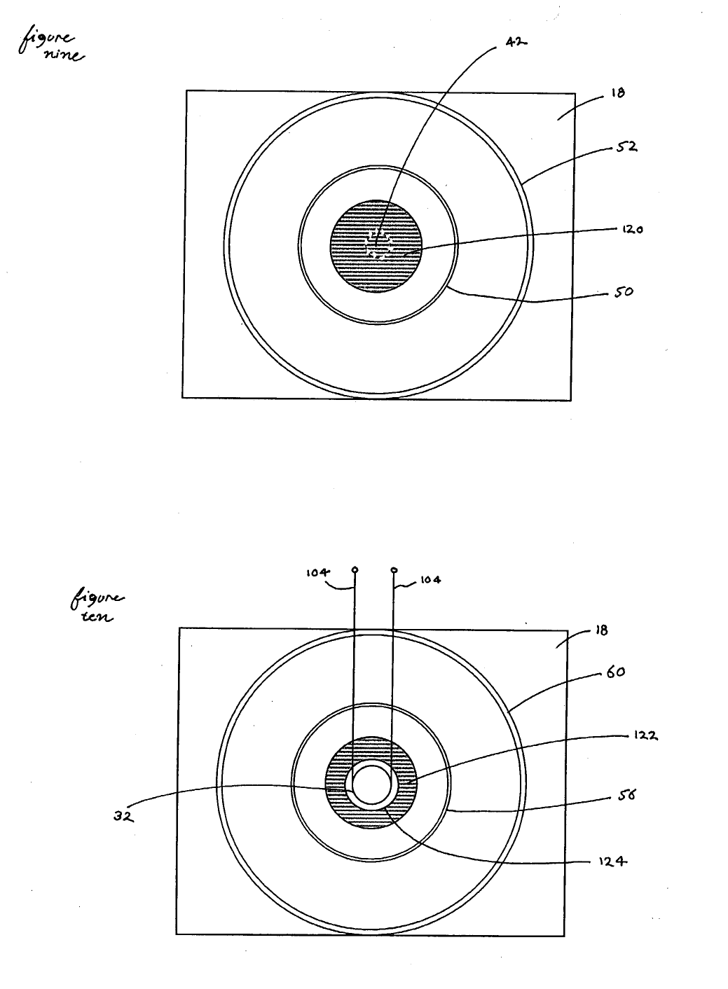

The compliance rings, lines or corrugations formed in the diaphragm 18 can be variously spaced and arranged. As shown in the drawings it has been found desirable in some constructions to provide concentric grooves 50 and 52 in the front or outer face of the diaphragm 18 and to provide the rear face of the diaphragm with a plurality of grooves which differ in diameter from the grooves 50 and 52 so as to be spaced radially therefrom. As shown in FIGS. 3 and 6, the grooves 54 and 56 on the rear face of the diaphragm 18 are positioned adjacent to and on opposite sides of the inner or smaller diameter groove 50 in the front face of the diaphragm whereas the grooves 58 and 60 in the rear face of the diaphragm are similarly located adjacent and on opposite sides of the outer or larger diameter groove 52 in the front face of the diaphragm. Preferably, the inner groove 50 and the associated grooves 54 and 56 on the opposite side of the diaphragm 18 are somewhat greater in width than the outer groove 52 and its companion grooves 58 and 60. The depth of the grooves 50 and 52 in the front of the diaphragm can also be slightly less than the depth of the grooves in the rear face of the diaphragm. However, these dimensional characteristics of the grooves and the diameter thereof can be varied as desired for a particular application. In any case, it is generally preferred to employ an inner groove 50 which is so spaced radially from the voice coil form 24 as to enclose the area equal to about 50 percent or more of the total area of the diaphragm 18.

It will further be noted from FIGS. 1 and 6 that the outer groove 52 on the front of the diaphragm 18 can extend substantially to the edge of the diaphragm, whereas the corresponding groove 60 on the inner surface of the diaphragm can terminate short of the edge of the diaphragm so as to be essentially arcuate in form. Moreover, the positions of the front groove 52 which are close to the edges of the diaphragm can be extended laterally as indicated at 61 and be filled with yieldable material 65 to offset or prevent marginal influence on the functioning of the diaphragm during vibration.

The compliance grooves, as described above, allow the diaphragm to respond to, and to faithfully reproduce, tones and sounds which vary materially in frequency, whereby the tendency for nodal points or interfering or out-of-phase vibrations to develop in different portions of the diaphragm is materially reduced. However, there is a tendency for such a fully complaint diaphragm to lose its integrity or unitary character so as to present substantially uncoupled zones whereby low-frequency vibrations may not be faithfully reproduced or may be distorted. Thus, in modified embodiments, a yieldable elastic composition 62, such as a silicone rubber material, is inserted into the grooves 50 and 52 in the front face of the diaphragm. This yieldable elastic composition 62 imposes a limited restraint between the zones of the diaphragm at opposite sides of the compliance grooves. If desired, a similar yieldable or elastic material can be inserted in the rear grooves of the diaphragm also. Such elastic or yieldable material accordingly serves as a filter to reduce vibrational coupling between the zones of the diaphragm on opposite sides of the compliance grooves, thereby reducing undesirable or excessive break-up, and independent or completely isolated vibration of the zones or elements of the diaphragm. Consequently, a more uniform and accurate response of the complete diaphragm during vibration at low frequencies is attainable. For example, a loss in response may develop in the range of about 600 Hz if the yieldable elastic composition 62 in the compliance grooves 50 and 52 in the front of the diaphragm is omitted. In contrast, a more uniform response is attained if the yieldable elastic composition 62 is disposed in the compliance grooves 50, 52, because the yieldable elastic composition 62 reduces vibrational coupling between the zones of the diaphragm on opposite sides of the compliance groves.

The piston action of the full diaphragm, when it is rectangular in shape as illustrated in the drawings, is improved, and distortion can be reduced by providing zones of freedom adjacent the mid-portions of the marginal edges 16 of the diaphragm. Consequently, in a modified embodiment, as illustrated in FIGS. 1, 3 and 5, the diaphragm supporting ledges 12 of the side members 4, 6, 8 and 10 of the frame 2 are cut away or molded so as to be of lesser height than the remainder of said ledges 12 to form zones of freedom 94, 96, 98 and 100 respectively. In addition, limited points or “dabs” of less yieldable bonding material 102 can be located at the central portions of the zones of freedom 94, 96, 98 and 100. Thus, the marginal portions 16 adjacent the mid-portions of the edges of the diaphragm 2 are characterized by limited but restrained freedom of movement which serves to reduce or prevent distortion, rubbing, or buzzing. In addition, these bonds serve to stabilize the positioning of the whole diaphragm by minimizing or reducing the effects of cold flow of the bonding cements 48. As shown in FIG. 5, the zones of freedom 94, 96, 98 and 100 also afford air release passages about the edges of the diaphragm which serve to diminish the damping action of the air adjacent the edges of the diaphragm during vibration thereof.

A modified embodiment of the sound reproducing equipment is illustrated in FIGS. 9 and 10. In such embodiments, the sound reproducing equipment further comprises support structures 120, 122 affixed to either side of the diaphragm 18. Such support structures are configured to extend the operating lifetime of the sound reproducing equipment, and specifically to reduce or prevent cracking of the diaphragm during reproduction of high frequencies or high volumes. In particular, because of the low structural integrity of expanded polystyrene materials and other similar materials, the diaphragm 18 is susceptible to cracking adjacent to the central opening 42, especially during reproduction of high frequencies or high volumes, and despite the presence of the compliance grooves disclosed above. In addition, the low structural integrity of expanded polystyrene can also cause the voice coil to pull a surface layer of polystyrene from the diaphragm and separate therefrom during reproduction of high frequencies and high volumes. The presence of support structures 120, 122 increases the structural integrity of the diaphragm 18, and of the joint between the diaphragm and the voice coil 32, thus allowing high volumes and high frequencies to be reproduced without adversely affecting the operating lifetime of the diaphragm 18.

Thus, in such embodiments, support structure 120 is affixed to the front side of the diaphragm 18 (illustrated in FIG. 9) and support structure 122 is bonded to the rear side of the diaphragm 18 (illustrated in FIG. 10). In a preferred embodiment, support structures 120, 122 comprise a thin sheet of Mylar having an adhesive disposed on one side to facilitate attachment to the diaphragm 18. The Mylar support structures can be opaque or transparent. Support structure 122, which is bonded to the rear of the diaphragm 18, preferably has an opening 124 at its center to accommodate the voice coil 32 and the lead wires 104. In a preferred embodiment, the support structures 120, 122 are approximately 0.005 inches thick, and preferably have a maximum diameter of between approximately 1 inch and approximately 6 inches. More preferably, the support structures 120, 122 have a maximum diameter of approximately 4 inches. The diameter of the opening 124 in the rear support structure 122 is approximately equal to the diameter of the voice coil 32. Such dimensions are configured to provide maximum structural support to the diaphragm while minimally affecting the acoustic properties of (for example, minimally damping) the diaphragm.

One of ordinary skill in the art will recognize that these dimensions are not critical to the function of the support structures 120, 122, and that other equivalent embodiments can have support structures comprising other materials or having other dimensions or shapes. In addition, one of ordinary skill in the art will recognize that in other embodiments, only one support structure (for example, only the front support structure or only the rear support structure) will be affixed to the diaphragm. Likewise, the support structure(s) can be affixed to the diaphragm by an adhesive, by bonding, or by any other technique known to one of ordinary skill in the art for securing plastic materials together.

To further extend the range, fidelity and operating lifetime of the sound reproducing equipment disclosed herein, in certain embodiments the sound reproducing equipment further comprises a high-frequency propagator. In such embodiments, the voice coil form 24, which is tubular in shape, is formed of plastic coated paper, light metal such as aluminum, or other suitable material, and is secured to the diaphragm 18 by molding, cementing or otherwise attaching it fixedly and accurately in place adjacent the center of the diaphragm. The portion of the diaphragm surrounding the voice coil form has an inward and downward taper 66 that presents an outwardly facing horn effect while still allowing the forward extremity 68 of the voice coil form to project in front of the adjacent portions of the diaphragm.

In preferred embodiments, the high-frequency propagator 70 further comprises an element 72 that presents a convex marginal surface 74 which is cemented or otherwise secured at its edges to the projecting extremity 68 of the voice coil form 24. The center of the element 72 is provided with a depression 76 surrounded by the vibratory element 78. In one embodiment, the vibratory element comprises a thin metal ring having an inwardly and downwardly inclined attaching rim 80 cemented or otherwise fixed at its inner edge to the convex surface 74 of the element 72. The outer free marginal edge 84 of the vibratory element 78 is inclined toward the surface of the diaphragm and over the adjacent taper 66 so as to be spaced therefrom. In such embodiments, the high-frequency propagator is actuated directly and positively by the voice coil form in response to undamped vibrations induced by the voice coil and magnet assembly, thus improving high frequency response. In addition, the taper 66 of the diaphragm directly adjacent the vibrating free edge 84 of the propagator aids in directing such vibrations forwardly with the lower frequency vibrations created by the piston action of the diaphragm as a whole.

Thus, the entire spectrum of frequencies, from the lowest tones to the highest pitch sounds, are faithfully reproduced by the various elements of the combination whereas only the minimum amplitude of piston motion is required. Accordingly, both electrical and mechanical distortion are substantially reduced and increased electromagnetic efficiency is attained despite the unusually wide range of frequencies and response resulting upon operation of the equipment.

In other embodiments, to further reduce the development of undesired induced or electromagnetic interference, the lead wires 104 through which current is supplied to the voice coil 32 are mounted in fixed positions with respect to each other so that they cannot move relative to each other during vibration of the diaphragm. For this purpose a terminal strip or connecting element 106 is mounted on the frame 2 and preferably is embedded in the material comprising the frame. As shown in FIG. 2, the lead wires 104 can also be embedded or molded into the material used in forming the diaphragm 18. However, as shown in FIGS. 5 and 7, it is generally preferable to provide grooves 108 in the diaphragm and to place the lead wires 104 in these grooves, after which the lead can be covered and embedded in a material such as a silicone rubber composition 110 which substantially fills the grooves.

An additional advantage of stiff, flat diaphragms produced by the molding of cellular polystyrene, such as expanded polystyrene beads, resides in the fact that the quality of the tone produced is improved when the surface of the diaphragm 18 is treated to remove the “skin” or continuous surface produced during the molding thereof. It is therefore desirable to remove such “skin” by roughening the surface of the diaphragm. This is preferably accomplished by applying acetone (or any other solvent agent) and a dye or pigment to the diaphragm surface to simultaneously remove the “skin” and color the diaphragm so that it will be invisible or blend with the color of any thin fabric or decorative covering material applied over the assembly in any installation to conceal the sound reproducing elements of the construction.

While the constructions shown and described herein are typical of sound reproducing equipment embodying the present invention, it will be apparent that the frame and diaphragm can be circular or elliptical in shape and can be constructed in various other ways in order to adapt the invention to thin, light weight equipment having other or special applications. Thus, it should be understood that the particular devices shown in the drawings and described above are intended to be illustrative only and are not intended to limit the scope of the invention.

B. Description of a Novel and Non-obvious User Configurable Multi-component Speaker Panel.

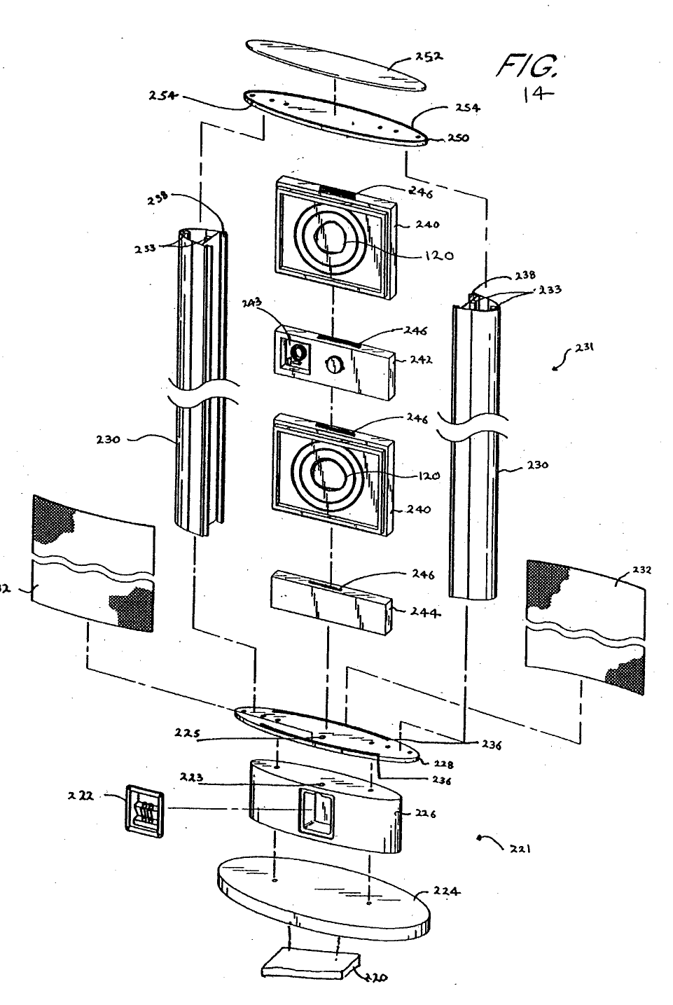

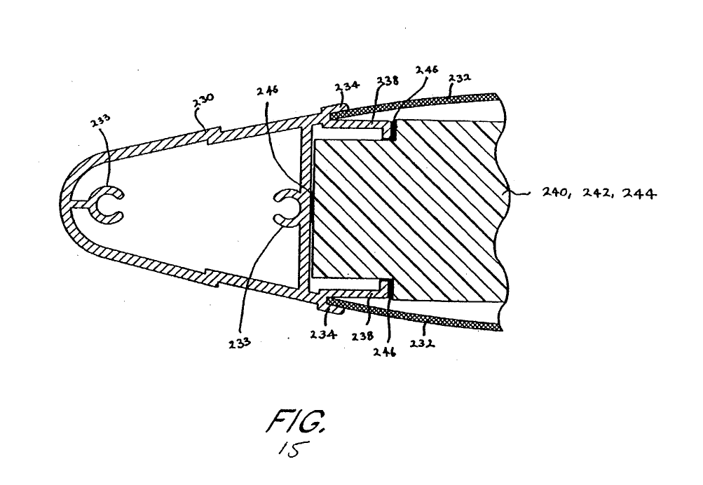

FIGS. 11 through 15 schematically illustrate a preferred embodiment of a user configurable multi-component speaker panel 210. This embodiment comprises a base 221 and an elongated component retaining device 231 that is securably attached to the base 221. The elongated component retaining device 231 is adapted to receive a plurality of loudspeaker components such that the loudspeaker components stack atop the base 221 and atop each other.

As illustrated in FIG. 14, in certain embodiments, the base 221 further comprises an anchor 220, a loudspeaker connector port 222, a base footing 224, a base support 226, and a base platform 228. The anchor 220 is adapted to fit into a recessed portion (not shown) of the base footing 224 and can be securably attached to the base footing 224 using screws, braces, nails, adhesives, or any other fastening mechanism. The anchor 220 is preferably comprised of a material having a high mass density, and thereby the anchor 220 effectively lowers the center of gravity of the entire speaker panel 210. A low center of gravity reduces the susceptibility of the speaker panel 210 to tip. The speaker panel 210 can be susceptible to tipping if placed on any of the uneven surfaces, such as tile or carpet, that can be found in contemporary dwellings and offices. In a preferred embodiment, the anchor 220 is a rectangular block measuring approximately 28 cm×13 cm×1.5 cm. Alternatively, the susceptibility of the loudspeaker assembly to tip can be reduced by fabricating the base footing 224 of a material having a high weight density, thereby allowing the anchor 220 to be omitted.

The base footing 224 can be securably attached to the base support 226 using screws, nails, adhesives, or any other fastening mechanism. In a preferred embodiment, the base footing 224 is approximately 3.0 cm high, has a maximum width of approximately 48 cm, and a maximum depth of approximately 19 cm; and the base support 226 is approximately 15 cm high, has a maximum width of approximately 36 cm, and a maximum depth of approximately 6.5 cm. Additionally, the base support 226 can be securably attached to the base platform 228 using screws, nails, adhesives, or any other fastening mechanism. In a preferred embodiment, the base platform 228 is approximately 1.2 cm high, has a maximum width of approximately 44 cm, and a maximum depth of approximately 8.3 cm. The base footing 224, base support 226, and base platform 228 are comprised of wood in a preferred embodiment, although one of ordinary skill in the art will recognize that any other rigid material such as aluminum or plastic could also be used to comprise these components. Alternatively, the base 221 can comprise a single element that performs all of the functions of the anchor 220, base footing 224, base support 226 and base platform 228. More generally, one skilled in the art will recognize that any of the elements comprising the base 221 can be combined to form a single element. In any of such embodiments, the base 221 would further comprise a recessed portion adapted to house the loudspeaker connector port 222.

The loudspeaker connector port 222 is adapted to receive one or a plurality of speaker input wires (not shown) from an audio signal source, such as an amplifier. In a preferred embodiment, the loudspeaker connector port 222 can comprise Pro-Tech Part No. 260-304, available from Parts Express International (Dayton, Ohio). The speaker input wires can be passed from the loudspeaker connector port 222 through the interior of the base support 226 via hole 223 and through the interior of the base platform 228 via hole 225. The speaker input wires can then connect to the plurality of loudspeaker components stacked above the base platform 228. The holes 223 and 225 can be adapted to accommodate a plurality of speaker input wires, thereby providing an independent audio signal to the plurality of loudspeaker components stacked above the base platform 228.

The base platform 228 is adapted to receive two elongated grooved rails 230. The elongated grooved rails 230 have one or more screw housings 233 that can be secured to the base platform 228 using screws, nails, adhesives or any other fastening mechanism. The screw housings 233 can run the entire length of the elongated grooved rails 230, or they can be located only at the ends of the elongated grooved rails 230. In a preferred embodiment, the elongated grooved rails are comprised of extruded aluminum, although one of ordinary skill in the art would recognize that any other rigid material such as wood or plastic can also be used. As illustrated in FIG. 15, each of the elongated rails 230 have two lips 234 that are adapted to receive two flexible opaque screens 232 that are approximately the same height as the elongated rails. Additionally, as illustrated in FIG. 14, the base platform 228 has two screen grooves 236 that are each adapted to receive the bottom end one of the two flexible opaque screens 232. The flexible opaque screens 232 are adapted to allow sound waves to pass therethrough substantially unaffected, while substantially preventing light from passing therethrough. In a presently preferred embodiment, the elongated rails 230 and the flexible opaque screens 232 are approximately 120 cm high.

Referring generally to FIGS. 14 and 15, each of the elongated grooved rails 230 preferably has two interior flanges 238 that run along the entire length of the rail. The interior flanges 238 are adapted to allow a plurality of various loudspeaker components 240, 242, 244 to be positioned between the elongated flanges 238 and to stack atop the base platform 228. As described previously, in a preferred embodiment, separate speaker drivers are used to reproduce separate frequency ranges while still maintaining an overall thin configuration for the speaker assembly. In particular, the mid-range frequencies are reproduced by thin speaker driver 240 having a diaphragm and/or frame comprised of thin polystyrene or suitable plastic material, as disclosed in U.S. Pat. No. 3,569,638, which is hereby incorporated herein by reference. The various loudspeaker components can comprise one or multiple mid-range speakers with a diaphragm formed from a cellular plastic material 240, high-frequency “tweeter” speaker assemblies 242, and/or spacers 244.

Because the tweeter speaker assembly 242 is readily configured in a slim package, as will be understood by one of ordinary skill in the art, the entire speaker panel 210 advantageously maintains the overall slim design. Moreover, the base portion 221 of the speaker panel 210 is large enough to contain a subwoofer speaker element and thus still maintaining the slim design while providing superior acoustic reproduction across the entire audible frequency spectrum. The tweeter assembly 242 includes a standard crossover circuit 243 commonly found in speaker designs. The crossover circuit 243 is designed to filter out and deliver to each speaker component only those frequencies of the audible spectrum that such speaker component is intended to reproduce. In accordance with a preferred embodiment, the crossover circuit 243 is designed to have a high-frequency crossover point at approximately 2 kHz. In another preferred embodiment in which a subwoofer is included as part of the speaker panel 210, the crossover circuit 243 has a high-frequency crossover point at approximately 2 kHz and a low-frequency crossover point at approximately 120 Hz.

Each of the various loudspeaker components 240, 242, 244 can be positioned by sliding them between the interior flanges 238 of the elongated grooved rails 230 such that the components stack in a user-configured order. Additionally, one of ordinary skill in the art will recognize that any means of securably stacking the various loudspeaker components 240, 242, 244 atop the base platform 228 can be employed. For example, the elongated grooved rails 230 can further comprise an elongated keyed protrusion of arbitrary shape adapted to receive various speaker components with a recessed keyed portion of the same arbitrary shape. Alternatively, the speaker panel 210 can further comprise one or more rods (not shown) of approximately the same height as the elongated grooved rails 230, wherein said rod is adapted to receive various loudspeaker components 240, 242, 244 that have hollowed out regions adapted to receive and pass therethrough said rod.

Each of the various loudspeaker components 240, 242, 244 preferably also comprises a plurality of tape strips 246 comprised of 50% wool and 50% Dacron®, although in other embodiments the tape strips 246 can comprise any other low-friction, shock-absorbent material, such as cork. As illustrated in FIGS. 14 and 15, the tape strips 246 can be disposed on any of the portions of the various loudspeaker components 240, 242, 244 that slide along the interior flanges 238 of the elongated grooved rails 230. As further illustrated in FIG. 14, the tape strips 246 can also be disposed on the portions of the various loudspeaker components 240, 242, 244 that contact other various loudspeaker components 240, 242, 244 when stacked. Regardless of where they are disposed, and of the material from which they are comprised, the tape strips 246 are adapted to facilitate the sliding of the various speaker components and to prevent the various speaker components from vibrating against the elongated grooved rails 230 or from vibrating against each other when stacked.

In other embodiments, the various loudspeaker components 240, 242, 244 and the elongated grooved rails 230 can be manufactured with a chamfer, thereby allowing these components to be snap-fit together. In such embodiments, the various loudspeaker components 240, 242, 244 can be added to or removed from the speaker panel 210 by temporarily removing one of the flexible opaque screens 232 and by snapping the desired loudspeaker components into or out of the elongated grooved rails 230 at the desired location along the elongated grooved rails 230. Such configurations can be advantageous if a loudspeaker component is sought to be added between several previously-stacked loudspeaker components or if a loudspeaker component is sought to be removed from a position surrounded by several previously-stacked loudspeaker components.

As illustrated in FIGS. 11 through 15, certain embodiments further comprise a cap 250 and an ornamental cover 252. The cap 250 can be securably attached to the top of the two elongated grooved rails 230 by means of one or more screw housings 233 using screws, bolts, or any other removable fastening mechanism. The screw housings 233 can run the entire length of the elongated grooved rails 230, or they can be located only at the ends of the elongated grooved rails 230. The cap 250 can further comprise two screen grooves (not shown) adapted to receive the top ends of the two flexible opaque screens 232. The cap 250 is adapted to secure the two elongated grooved rails 230, and to prevent objects or dust from falling into the cavity containing the various loudspeaker components 240, 242, 244 that have been stacked atop the base platform 228. In a preferred embodiment, the cap 250 is approximately 1.3 cm high, has a maximum width of approximately 42 cm, and has a maximum depth of approximately 8.3 cm. In modified embodiments, cap 250 further comprises a recessed portion defined by the raised flange 254, wherein the recessed portion of the cap 250 is adapted to receive an ornamental cover 252. In a preferred embodiment, the ornamental cover 252 is approximately 0.64 cm high, has a maximum width of approximately 41.5 cm, and has a maximum depth of approximately 7.8 cm. In such embodiments, the ornamental cover 252 and cap 250 are removable, thereby allowing the user to access the interior of the speaker panel 210. Although one preferred embodiment has been described fully in terms of its dimensions as shown, that preferred embodiment is readily adaptable and intended to be manufactured in all sizes and configurations, including from desktop speakers for personal computers measuring a few centimeters long to large auditorium-size speakers which can be several meters in length.

The various embodiments of the speaker panel 210 described herein allow the user to configure the audio characteristics of the sound produced by adjusting the types of loudspeaker components stacked along the elongated grooved rails 230 and atop the base platform 228. For example, certain users may prefer the audio characteristics produced when the high-frequency “tweeter” speaker assemblies 242 are placed at approximately the same elevation as the user's ears. Such users may obtain such audio characteristics by placing one or multiple high-frequency “tweeter” speaker assemblies 242 atop several spacers 244 or one or multiple mid-range speakers 240 that can have diaphragms formed from a cellular plastic material, as disclosed in U.S. Pat. No. 3,569,638. Alternatively, other users may prefer the audio characteristics produced when a high-frequency “tweeter” speaker assembly 242 is placed between two mid-range speakers 240, as is illustrated in FIG. 14. One of ordinary skill in the art will recognize that the speaker panel 210 can be configured to satisfy an unlimited number of users' various audio listening preferences while still providing the advantages of a small footprint, and a lightweight and compact assembly. Additionally, one of ordinary skill in the art will recognize that the speaker panel 210 can be specifically configured for use in certain applications wherein the listeners' ears may be located at different heights from the floor, such as in a dance room (where the listeners are generally standing), or in a home theater (where the listeners are generally seated).

The various embodiments of the speaker panel 210 described herein further allow the user to supplement existing loudspeaker components with new loudspeaker components as such components become available. New loudspeaker components may become available due to the elimination of budgetary or technological limitations. To add new components to the speaker panel 210, or to eliminate existing or outdated components form the speaker panel 210, the user merely removes the ornamental cover 252 and cap 250, and inserts (or removes) the desired components by sliding them along the elongated grooved rails 230. Alternatively, as described above, the user can add or remove one of the flexible opaque screens 232 and can snap any loudspeaker components manufactured with a chamfer into or out of the elongated grooved rails 230. After any loudspeaker components are added to the elongated grooved rails 230, the speaker input wires for any new components can then be threaded through the hole 225 in the base platform and through the hole 223 in the base support 226 to the loudspeaker connector port 222.

Additionally, the oblong, oval shape of various components described herein, and illustrated in the figures, is an aesthetic design choice and is not critical to the operation of the speaker panel 210. Various other shapes, such as a rectangle or circle, can also be used for such components. Furthermore, vertical stacking of the various loudspeaker components is not critical to the operation of the speaker panel 210. For example, the elongated grooved rails can be aligned horizontally, thereby allowing the various loudspeaker components to also be aligned horizontally.

Additional details regarding the thin speaker driver 240 having a diaphragm and/or frame comprised of thin polystyrene or suitable plastic material are provided in Section A, above.

### SCOPE OF THE INVENTION

The above presents a description of the best mode contemplated for the present user configurable multi-component speaker panel, and of the manner and process of making and using it, in such full, clear, concise and exact terms as to enable any person skilled in the art to which it pertains to make and use this user configurable multi-component speaker panel. This user configurable multi-component speaker panel is, however, susceptible to modifications and alternate constructions from those discussed above which are fully equivalent. Consequently, it is not the intention to limit this user configurable multi-component speaker panel to the particular embodiments disclosed. On the contrary, the intention is to cover all modifications and alternate constructions coming within the spirit and scope of the user configurable multi-component speaker panel as generally expressed by the following claims, which particularly point out and distinctly claim the subject matter of the user configurable multi-component speaker panel.

I claim:

1. A loudspeaker assembly, comprising:
at least one mid-range speaker with a substantially planar diaphragm comprised of a lightweight material;
at least one high-range speaker; and
two posts;
wherein the at least one mid-range speaker and the at least one high-range speaker can be positioned between the two posts during assembly, such that the relative positions of the at least one mid-range speaker, and the at least one high-range speaker are adjustable.

2. The loudspeaker assembly of claim 1, further comprising a base configured to support the two posts, the two posts being vertically oriented.

3. The loudspeaker assembly of claim 2, further comprising a cap positioned atop the two posts.

4. The loudspeaker assembly of claim 2, wherein the base houses a low-range speaker.

5. The loudspeaker assembly of claim 1, wherein the at least one mid-range speaker further comprises a support shield affixed to a planar diaphragm front surface.

6. The loudspeaker assembly of claim 1, wherein the at least one mid-range speaker further comprises a support shield affixed to a planar diaphragm rear surface.

7. The loudspeaker assembly of claim 5, wherein the first and second support shields are substantially circular.

8. The loudspeaker assembly of claim 1, further comprising at least one spacer configured to be positioned between the two posts.

9. The loudspeaker assembly of claim 1, wherein the two posts comprise two grooved rails, such that the at least one mid-range speaker and the at least one high-range speaker can slide therebetween.

10. The loudspeaker assembly of claim 9, wherein the at least one mid-range speaker and the at least one high-range speaker each comprise a chamfered edge, such that the at least one mid-range speaker and the at least one high-range speaker can be positioned between the two posts without sliding.

11. A method for configuring a loudspeaker assembly, comprising:
providing a plurality of loudspeaker components;
providing two posts configured to receive the plurality of loudspeaker components therebetween; and
positioning the plurality of loudspeaker components between said posts according to a user's listening preferences.

12. The method of claim 11, wherein the plurality of loudspeaker components comprise at least one speaker with a diaphragm comprised of a cellular plastic material.

13. The method of claim 12, wherein the at least one speaker with a diaphragm comprised of a cellular plastic material further comprises a support shield affixed to a diaphragm front surface.

14. The method of claim 12, wherein the at least one speaker with a diaphragm comprised of a cellular plastic material further comprises a support shield affixed to a diaphragm rear surface.

15. The method of claim 13, wherein the first and second support shields are substantially circular.

16. The method of claim 11, wherein the plurality of loudspeaker components comprise at least one high-range speaker.

17. The method of claim 11, wherein the plurality of loudspeaker components comprise at least one spacer.

18. The method of claim 11, further comprising mounting the two posts to a support base such that the two posts are vertically oriented.

19. The method of claim 18, wherein a cap is positioned atop the two posts.

20. The method of claim 18, wherein the support base houses a low-range speaker.

21. The method of claim 11, wherein the two posts comprise two grooved rails, such that the loudspeaker components can slide therebetween.

22. The method of claim 21, wherein the at least one of the loudspeaker components comprises a chamfered edge, such that the at least one loudspeaker component can be positioned between the two posts without sliding.
